(19) United States
(12) Patent Application Publication
(10) Pub. No.: US 2019/0375130 A1
(43) Pub. Date: Dec. 12, 2019

(54) PREFABRICATED COMPONENT MOLD

(71) Applicant: USUN (FOSHAN) TECHNOLOGY CO., LTD., Foshan (CN)

(72) Inventor: CHIU-FONG HUANG, New Taipei City (TW)

(21) Appl. No.: 16/258,944

(22) Filed: Jan. 28, 2019

(30) Foreign Application Priority Data
Jun. 6, 2018 (CN) 201810574738.7

(51) Int. Cl. B28B 7/00; B28B 7/36; B28B 1/14

(52) U.S. Cl. CPC B28B 7/0014; B28B 1/14; B28B 7/364

(57) ABSTRACT

A prefabricated component mold includes a number of side plates and a removable film. The side plates cooperatively define a molding cavity for molding a prefabricated cement component. The removable film is configured to be removably arranged on an inner side of the side plates for preventing the prefabricated cement component from contacting the side plates.

### FIELD

The subject matter herein generally relates to prefabricated component molds, and more particularly to a prefabricated component mold for being easily separated from a cement component molded therein.

### BACKGROUND

Generally, cement components are prefabricated in molds. After the cement component is molded, the mold must be disassembled from the cement component. However, the mold may sometimes stick to the molded cement component, and cement of the cement component may build up on a surface of the mold.

Therefore, there is room for improvement within the art.

### BRIEF DESCRIPTION OF THE DRAWINGS

Implementations of the present disclosure will now be described, by way of example only, with reference to the attached figures.

FIG. 1 is an assembled, isometric view of an embodiment of a prefabricated component mold in accordance with an embodiment of the present disclosure.

FIG. 2 is a cross-sectional view of the prefabricated component mold in FIG. 1.

FIG. 3 is a close up view of an inserting member.

FIG. 4 is a cross-sectional view of a second embodiment of a prefabricated component mold.

FIG. 5 is a flowchart of a method for using the prefabricated component mold in FIG. 1.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

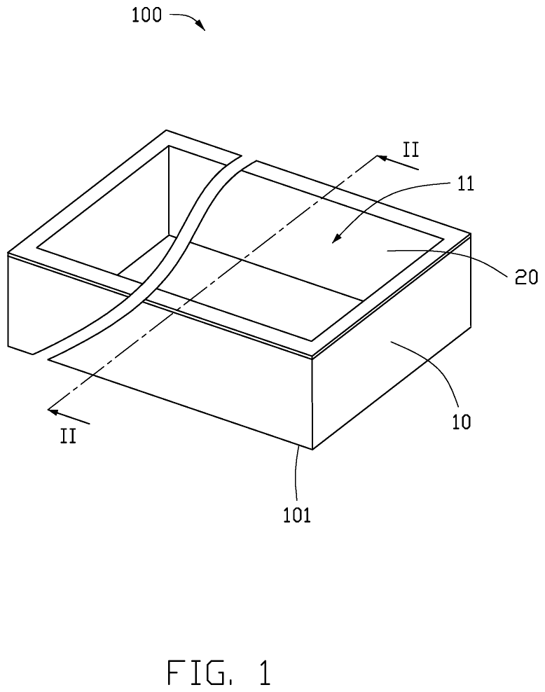

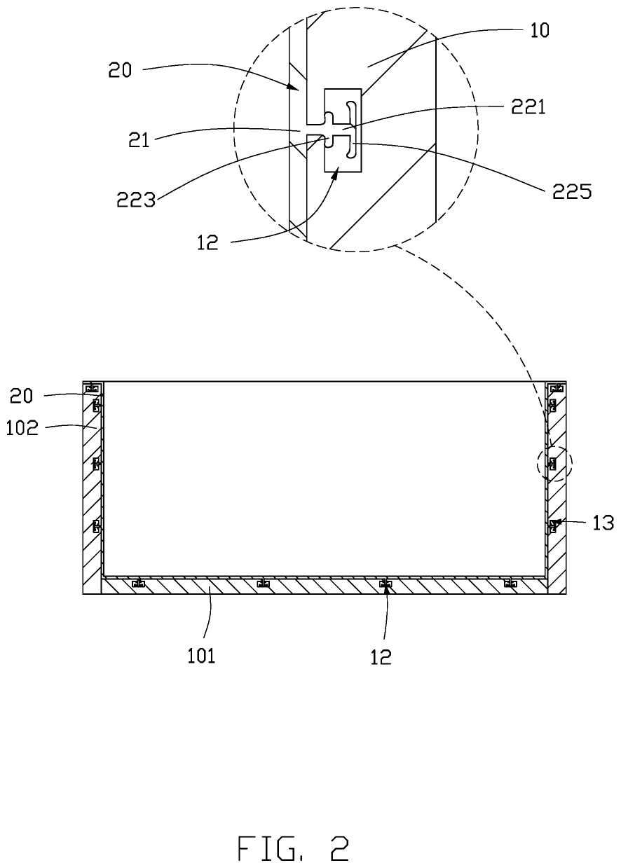

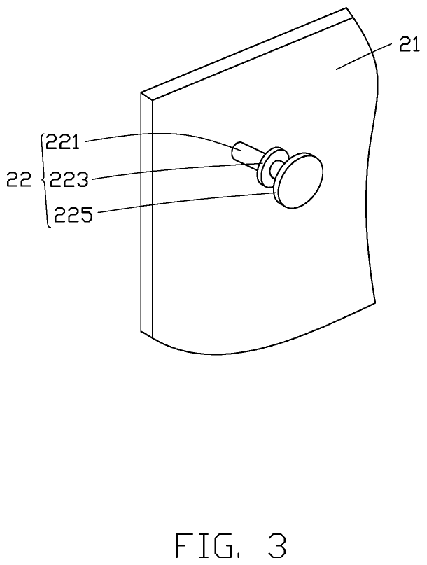

FIGS. 1-3 show an embodiment of a prefabricated component mold 100 for fabricating a cement component. The prefabricated component mold 100 includes a plurality of side plates 10 and a removable film 20. The plurality of side plates 10 surround and cooperatively define a molding cavity 11. The molding cavity 11 is used for receiving cement for fabricating a component. The removable film 20 is arranged on the plurality of side plates 10. The removable film 20 prevents the cement from contacting the side plates 10. In at least one embodiment, the removable film 20 is made of silica gel. After the cement component is fabricated, the silica gel is easily removed from the cement component.

The cement component may be, but is not limited to, a prefabricated or partially fabricated wall, floor slab, stair step, or window component.

In at least one embodiment, a quantity of the side plates 10 is four. The prefabricated component mold 100 further includes a bottom plate 101. Each of the side plates 10 is arranged on a side of the bottom plate 101. The four side plates 10 and the bottom plate 101 cooperatively surround and define the molding cavity 11.

It should be understood that in other embodiments, the bottom plate 101 may be omitted, and the side plates 10 may be arranged around a core band or steel plate.

It should be understood that in other embodiments, a quantity of the side plates 10 can be more or less than four, as long as the side plates 10 define the molding cavity 11.

In at least one embodiment, every two adjacent side plates 10 are locked together to the bottom plate 101 by screws. It should be understood that in other embodiments, the bottom plate 101 and the side plates 10 may be jointly formed.

An inner surface of the bottom plate 101 and the side plates 10 define a plurality of fixing holes 12. Each fixing hole 12 on the bottom plate 101 has an opening width less than a width of an inner portion of the fixing hole 12.

The removable film 20 includes a main body 21 and a plurality of inserting members 22. The inserting members 22 face the bottom plate 101 or one of the side plates 10. Each inserting member 22 is inserted into a corresponding one of the fixing holes 12 to be fixed in the fixing hole 12.

The inserting member 22 includes a rod body 221, a first annular portion 223, and a second annular portion 225. The first annular portion 223 and the second annular portion 225 are arranged on the rod body 221. The first annular portion 223 is adjacent to a main body 21 of the rod body 221. The second annular portion 225 is located at an end of the rod body 221 away from the main body 21. A width of the first annular portion 223 is less than a width of the second annular portion 225. The width of the first annular portion 223 and of the second annular portion 225 are each larger than the width of the opening of the fixing hole 12. The first annular portion 223 and the second annular portion 225 are configured to deform to snap fit in the fixing hole 12 to be fixed in the fixing hole 12. After the inserting member 22 is inserted into the fixing hole 12, the first annular portion 223 resists against a wall of the opening of the fixing hole 12, and the second annular portion 225 resists against a bottom wall of the fixing hole 12. When the bottom plate 101 and the side plates 10 are separated from the cement component, the first annular portion 223 and the second annular portion 225 are limited by the inner wall of the opening of the fixing hole 12 to fix the removable film 20 to the bottom plate 101 and the side plates 10.

In at least one embodiment, a top surface of the side plates 10 deviating away from the bottom plate 101 also defines fixing holes 12. The removable film 20 is further covered over the top surface of the side plates 10 to prevent splattered cement from contacting the top surface of the side plates 10.

It should be understood that in other embodiments, one of the first annular portion 223 and the second annular portion 225 may be omitted, such that the other one of the first annular portion 223 and the second annular portion 225 is able to adequately fix the inserting member 22 in the fixing hole 12.

It should be understood that in other embodiments, the inserting member 22 may be omitted, such that the removable film 20 is fixed to the bottom plate 101 or the side plates 10 by an adhesive or a clamping member, for example.

In at least one embodiment, the removable film 20 is a single component. It should be understood that in other embodiments, the removable film 20 may be composed of a plurality of silica gel films.

It should be understood that in other embodiments, the removable film 20 may be made of rubber, polyurethane, or other material capable of being easily removed from cement and having elasticity.

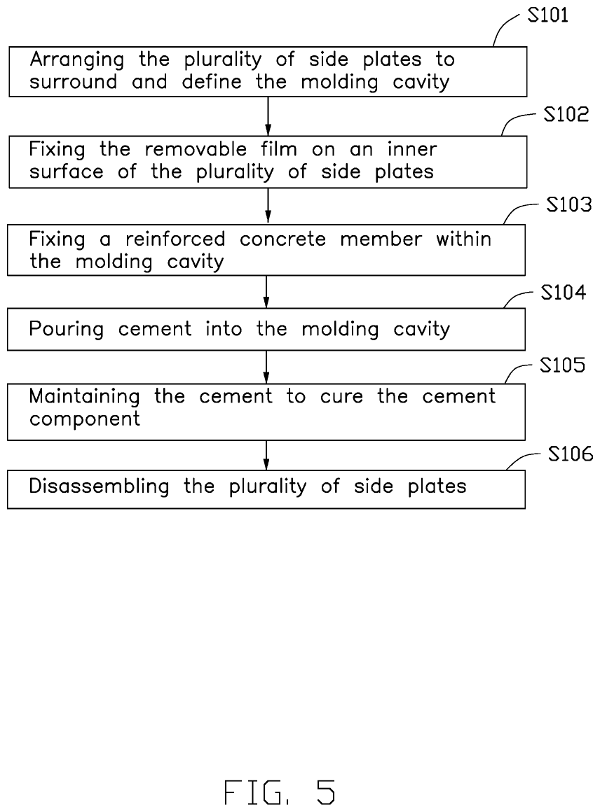

FIG. 5 illustrates a flowchart of an exemplary method for using a prefabricated component mold. The example method is provided by way of example, as there are a variety of ways to carry out the method. The method described below can be carried out using the configurations illustrated in FIGS. 1-3, for example, and various elements of these figures are referenced in explaining the example method. Each block shown in FIG. 5 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block S101.

At block S101, the plurality of side plates 10 are cooperatively arranged to surround and define the molding cavity 11.

In at least one embodiment, four side plates 10 are directly connected together to define a rectangular molding cavity 11. It should be understood that in other embodiments, a quantity of the side plates 10 and a shape of the molding cavity 11 are determined according to a shape of the component to be molded.

At block S102, the removable film 20 is fixed on an inner surface of the plurality of side plates 10.

In at least one embodiment, the inserting member 22 is inserted into the fixing holes 12 of the side plates 10. The first annular portion 223 and the second annular portion 225 are deformed to snap fit in the fixing holes 12.

At block S103, a reinforced concrete member is fixed within the molding cavity 11.

At block S104, cement is poured into the molding cavity 11.

At block S105, the cement is maintained to cure the cement component.

In at least one embodiment, the prefabricated component mold is placed in a thermostatic chamber and watered everyday to maintain. It should be understood that in other embodiments, other maintaining method(s) may be employed.

At block S106, the plurality of side plates 10 are disassembled.

The removable film 20 prevents the side plates 10 from contacting the cement component. The first annular portion 223 and the second annular portion 225 are limited by the inner wall of the opening of the fixing hole 12 to fix the removable film 20 to the bottom plate 101 and the side plates 10.

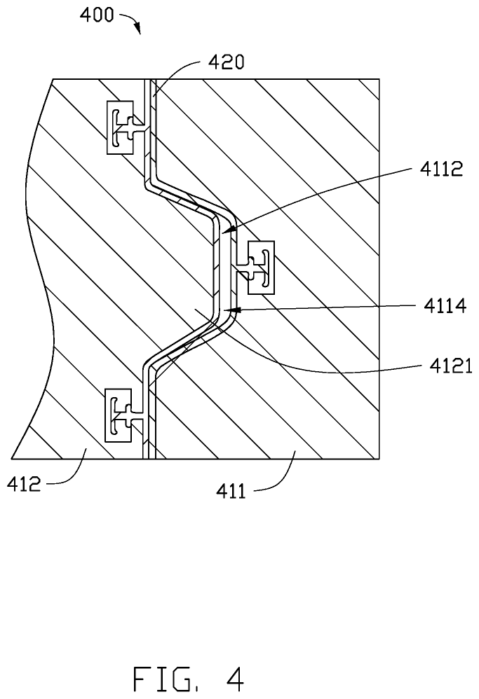

FIG. 4 illustrates a second embodiment of a prefabricated component mold 400. The prefabricated component mold 400 is similar to the prefabricated component mold 100. The difference is that the prefabricated component mold 400 includes a first molding plate 411 and a second molding plate 412. The first molding plate 411 concavely defines an accommodating slot 4112. A cross-sectional view of the accommodating slot 4112 is substantially step-shaped. The second molding plate 412 includes a protruding portion 4121. The protruding portion 4121 is substantially step-shaped. The protruding portion 4121 is configured to protrude into and seal the accommodating slot 4112 to define a molding cavity 4114. The molding cavity 4114 receives cement to be molded. The removable film 420 is arranged on opposite sides of the first molding plate 411 and the second molding plate 412. The removable film 420 prevents the cement from contacting the first molding plate 411 and the second molding plate 412.

The prefabricated component mold 100 uses the removable film 20 to prevent the cement component from contacting the cement component the side plates 10. The removable film 20 is easily removed from the cement component. The side plates 10 do not come in contact with the cement component to maintain cleanliness of the side plates 10.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A mold for molding a prefabricated cement component, the mold comprising:
a plurality of side plates cooperatively defining a molding cavity for molding a prefabricated cement component;
a removable film configured to be removably arranged on inner surfaces of the plurality of side plates for preventing the prefabricated cement component from contacting the plurality of side plates.

2. The prefabricated component mold of claim 1, wherein the removable film is made of at least one of silica gel, rubber, or polyurethane.

3. The prefabricated component mold of claim 1, wherein the side plates define a plurality of fixing holes; the removable film comprises a main body and a plurality of inserting members arranged on the main body; each inserting member is inserted into a corresponding one of the fixing holes to be fixed into the fixing hole.

4. The prefabricated component mold of claim 3, wherein a width of an opening of the fixing hole is less than a width of an inner portion of the fixing hole; the inserting member comprises a rod body and a first annular portion on the rod body; a width of the first annular portion is greater than the width of the opening of the fixing hole; the first annular portion is configured to deform to snap fit into the fixing hole to be fixed in the fixing hole.

5. The prefabricated component mold of claim 4, wherein the inserting member further comprises a second annular portion; the first annular portion is located adjacent to the main body; the second annular portion is located at an end of the rod body away from the main body; the width of the first annular portion is less than a width of the second annular portion; after the inserting member is inserted into the fixing hole, the first annular portion resists against a wall of the opening of the fixing hole, and the second annular portion resists against a bottom wall of the fixing hole.

6. The prefabricated component mold of claim 3, further comprising a bottom plate; a quantity of the sidewalls is four; each of the four side plates is removably attached to a corresponding side of the bottom plate; the bottom plate and the four side plates cooperatively define the molding cavity; the fixing holes are defined in an inner surface of the bottom plate and the side plates; the removable film is removably arranged on an inner side of the bottom plate.

7. The prefabricated component mold of claim 6, wherein a top surface of the side plates deviating away from the bottom plate defines the fixing holes; the removable film is removably arranged on the top surface.

8. A mold for molding a prefabricated cement component, the mold comprising:
a first molding plate concavely defining an accommodating slot;
a second molding plate comprising a projecting portion extending into and sealing the accommodating slot; and
a removable film removably arranged on an inner surface of the first molding plate and the second molding plate for preventing a prefabricated cement component from contacting the first molding plate and the second molding plate.

9. The prefabricated component mold of claim 8, wherein the removable film is made of at least one of silica gel, rubber, or polyurethane.

10. The prefabricated component mold of claim 8, wherein the first molding plate and the second molding plate define a plurality of fixing holes; the removable film comprises a main body and a plurality of inserting members arranged on the main body; each inserting member is inserted into a corresponding one of the fixing holes to be fixed into the fixing hole.
